(19) United States
(12) Patent Application Publication
(10) Pub. No.: US 2007/0187437 A1
(43) Pub. Date: Aug. 16, 2007

(54) DISPENSING TIP FOR LIQUID DISPENSING SYSTEMS AND METHOD OF MAKING THE SAME

(75) Inventor: Steven F Lord, Rumford, RI (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 11/276,038

(22) Filed: Feb. 10, 2006

(51) Int. Cl. B65D 35/38; G01F 11/00

(52) U.S. Cl. 222/568; 222/386; 222/575

(57) ABSTRACT

A dispensing tip for a liquid dispenser includes a hub having a proximal end, a distal end and a first passageway therethrough, and an elongate tube having a proximal end, a distal end and a second passageway therethrough. The proximal end of the tube is coupled to the distal end of the hub such that the first and the second passageways are in fluid communication. A chamfered portion is formed adjacent the distal end of the tube wherein the tube wall thickness at the dispensing orifice is less than the tube wall thickness upstream of the dispensing orifice. The tube may have a maximum outer diameter of approximately 0.009 inch or less. The tube may also have a minimum wall thickness less than 0.0005 inch. A method for making the dispensing tip includes applying a chemical etchant to a tube to form the chamfered portion.

### FIELD OF THE INVENTION

This invention generally relates to liquid dispensing devices for a variety of purposes, and more particularly to a dispensing tip for liquid dispensing systems and a method of making the dispensing tip.

### BACKGROUND OF THE INVENTION

Various types of dispensers are used in many industries for placing liquids, such as hot melt adhesives, conformal coating materials, etc., onto substrates during an assembly process. For instance, in some electronic module assemblies, it is desirable to place a small amount, e.g., a micro dot, of adhesive on the module substrate during assembly. To this end, liquid dispensing systems include a dispensing tip that facilitates dispensing an appropriate amount of liquid in a desired location.

It may also be desirable to apply a liquid in a restricted space or region of the substrate. In these applications, the size of the dispensing tip is appropriately selected to correspond to the amount of liquid to be dispensed or the size of the region to which the liquid is being applied. Thus, suppliers of dispensing tips generally offer a range of sizes for use in a wide variety of dispensing applications. For instance, EFD, Inc. of East Providence, R.I. offers dispensing tips ranging between a 14 gauge tip (0.072 inch diameter) and a 32 gauge tip (0.009 inch diameter).

Typically, it is also important to dispense an amount of liquid in an efficient and clean manner. Thus, it is important for the dispensing tip to provide sufficient control of the dispensing process in order to deposit the liquid in the desired area and to provide a clean cutoff when the desired amount has been dispensed. To provide enhanced control over dispensing small amounts of liquid, the tip wall thickness at the dispensing orifice ( e.g., one half the difference between the outer and inner diameters at the orifice) may be minimized. Minimizing the tip wall thickness at the dispensing orifice reduces the capillary forces that allow liquid to undesirably creep beyond the outer edges of the dispensing tip and perhaps even up the tip.

One approach typically used to minimize the tip wall thickness at the dispensing orifice is to form a chamfer in the dispensing tip adjacent the dispensing orifice. A chamfer is a reduction in the outer cross dimension (e.g., outer diameter) of the dispensing tip from some nominal value to a lesser value at the most distal point or end of the dispensing tip. Thus, the chamfer reduces the outer cross dimension of the dispensing tip without affecting the inner cross dimension (e.g., inner diameter). This reduction in tip wall thickness at the dispensing orifice provides enhanced control over the dispensing process.

Besides providing for a reduced tip wall thickness, forming a chamfer in the dispensing tip adjacent the dispensing orifice has other advantages. For example, in some applications the structural requirements of the dispensing tip might prevent a larger gauge (smaller diameter) tip from being used. In such applications, a chamfered dispensing tip is advantageous as it, on the whole, provides structural features characteristic of smaller gauge tips while providing dispensing features characteristic of larger gauge tips. For example, a 30 gauge chamfered dispensing tip while having the strength and structural features associated with such larger dispensing tips, may be chamfered to dispense liquid in a manner more analogous to a smaller 32 gauge dispensing tip. The chamfered dispensing tips are also advantageous as the smaller gauge tips are easier to handle during manufacturing and use of the dispensing tips.

Conventional methods of producing chamfered dispensing tips include forming a chamfer in a constant diameter tip through a grinding process. For smaller gauge dispensing tips, such a grinding process is satisfactory for forming the chamfer. For larger gauge dispensing tips (i.e., 32 gauge dispensing tips and larger), however, the conventional grinding process has some limitations.

In particular, the grinding process often mechanically damages the dispensing tip by bending the tip, partially collapsing the inner lumen or passageway, etc., thereby diminishing the capacity of the dispensing tip to operate in a satisfactory manner. Moreover, the grinding process limits the minimization of the tip wall thickness at the dispensing orifice. Thus, for example, the grinding process may be used to achieve a tip wall thickness at the dispensing orifice of approximately 0.0005 inch. The use of the conventional grinding process to achieve tip wall thicknesses at the dispensing orifice of less than this value often results in mechanical damage to the dispensing tip, even for smaller gauge needles. Additionally, the grinding process results in a rough surface finish that often includes burrs and other irregularities that diminish control of the dispensing process.

Accordingly, there is a need for an improved dispensing tip having a chamfer formed therein and a method of making the same that addresses these and other drawbacks of current dispensing tips and methods.

### SUMMARY OF THE INVENTION

An embodiment of the invention provides a dispensing tip for a liquid dispenser that includes a hub having a proximal end, a distal end and a first passageway fluidly coupling the proximal and distal ends of the hub. The proximal end of the hub is adapted to be coupled to the liquid dispenser. The dispensing tip further includes a tube having a proximal end, a distal end defining a dispensing orifice and a second passageway fluidly coupling the proximal and distal ends of the tube. The proximal end of the tube is coupled to the distal end of the hub such that the first passageway in the hub and the second passageway in the tube are in fluid communication. The tube has a maximum outer diameter of approximately 0.009 inch or less. A chamfered portion is formed adjacent the distal end of the tube wherein the tube wall thickness at the dispensing orifice is less than the tube wall thickness upstream of the dispensing orifice.

In another embodiment of the invention, a dispensing tip for a liquid dispenser includes a hub having a proximal end, a distal end and a first passageway fluidly coupling the proximal and distal ends of the hub. The proximal end of the hub is adapted to be coupled to the liquid dispenser. The dispensing tip further includes a tube having a proximal end, a distal end defining a dispensing orifice and a second passageway fluidly coupling the proximal and distal ends of the tube. The proximal end of the tube is coupled to the distal end of the hub such that the first passageway in the hub and the second passageway in the tube are in fluid communication. A chamfered portion is formed adjacent the distal end of the tube wherein the tube wall thickness at the dispensing orifice is less than the tube wall thickness upstream of the dispensing orifice and is less than approximately 0.0005 inch.

A dispensing tip in accordance with embodiments of the invention may be made through a chemical etch process. To this end, a tube may be provided having an outer surface and an inner surface defining a passageway through the tube. A chemical etchant may be applied to at least a portion of the outer surface of the tube. A chamfered portion may then be formed through the application of the chemical etchant to the outer surface of the tube. In one aspect of the method, the chamfered portion may be formed in a tube having an outer diameter of approximately 0.009 inch or less. In another aspect of the method, the chamfered portion may define a minimum tube wall thickness of less than approximately 0.0005 inch.

These and other objects, advantages and features of the invention will become more readily apparent to those of ordinary skill in the art upon review of the following detailed description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a cross-sectional view of an exemplary dispensing system in accordance with the invention;

FIG. 2 is an enlarged view of the dispensing tip in the dispensing system of FIG. 1;

FIG. 3 is an enlarged cross-sectional view of the distal end of the elongate tube in the dispensing tip of FIG. 2;

FIG. 4 is a schematic diagram of a chemical etch process to make a dispensing tip in accordance with the invention;

FIG. 5A illustrates an alternate embodiment of the invention wherein the tube has a triangular cross section; and

FIG. 5B illustrates an alternate embodiment of the invention wherein the tube has a rectangular cross section.

### DETAILED DESCRIPTION

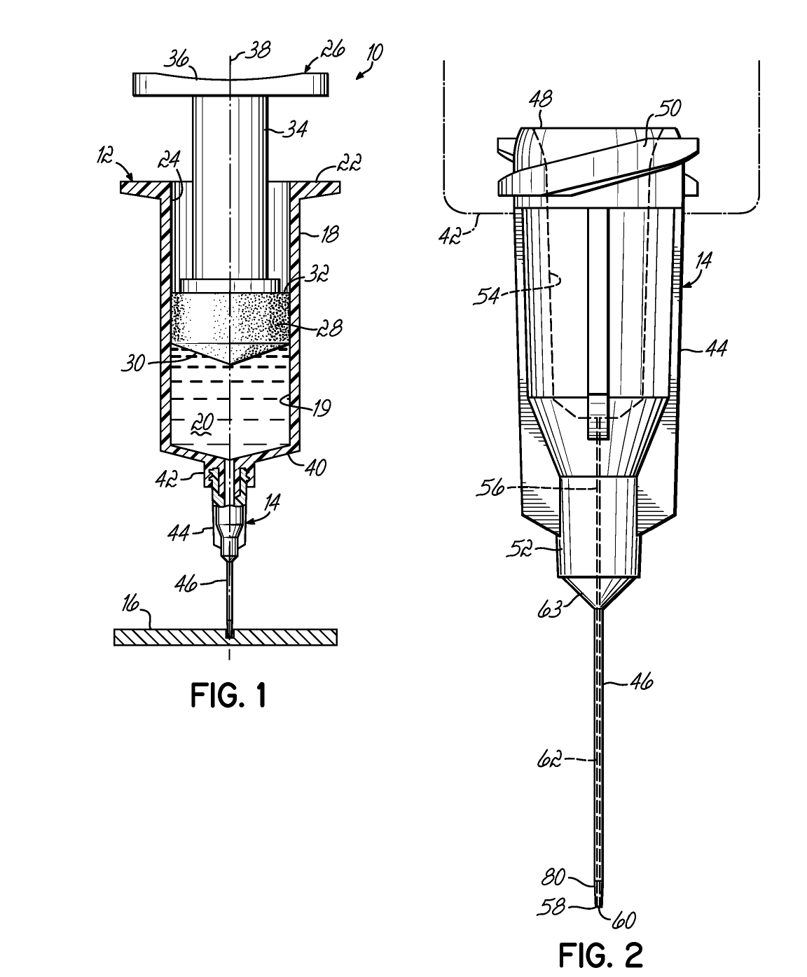

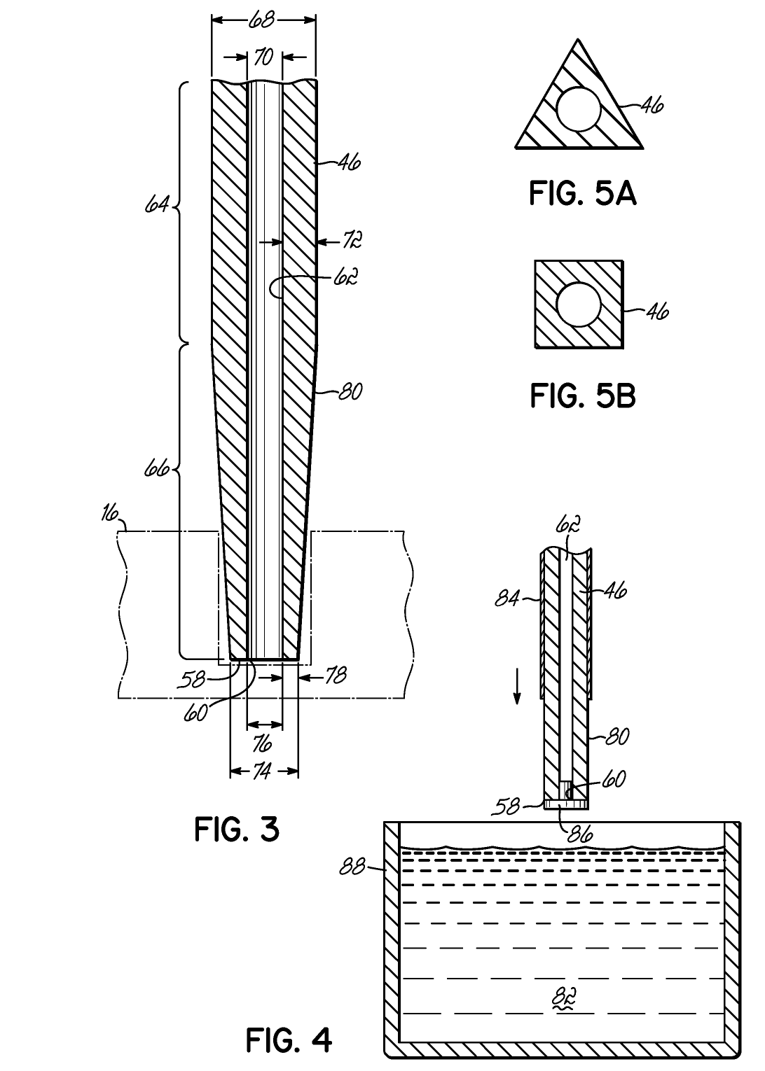

Referring to FIGS. 1-3, a dispensing system 10 for dispensing a liquid, such as an adhesive, conformal coating materials and other viscous materials, includes a liquid dispenser 12 and a dispensing tip 14 coupled to the liquid dispenser 12 to facilitate dispensing the liquid onto a substrate 16. As shown in the drawings, in one embodiment of the invention, the liquid dispenser 12 may be configured as a syringe-type of dispenser that may be manually actuated to dispense liquid from the dispensing tip 14. To this end, liquid dispenser 12 includes a dispensing body 18 that defines a reservoir 19 for holding a liquid 20 to be dispensed. A proximal end 22 of the dispensing body 18 includes an opening 24 for receiving a plunger assembly 26 that when actuated, pressurizes the liquid 20 in the reservoir 19 and causes liquid 20 to flow from the reservoir 19 through dispensing tip 14 and onto substrate 16.

The plunger assembly 26 includes a piston 28 that fits through opening 24 and fits snugly within dispensing body 18. Piston 28 includes a lower surface 30 adapted to face and contact the liquid 20 in reservoir 19 from above. Piston 28 further includes an upper surface 32 coupled to a stem 34 that extends through opening 24 and out of dispensing body 18. Plunger assembly 26 may further include a pad or button 36 at a terminal end of stem 34 for facilitating movement of the piston 28, such as by contact with a thumb or finger of an operator, along a longitudinal axis 38 of the dispensing body 18. In this way, an operator may control dispensing the liquid 20 onto the substrate 16. Those of ordinary skill in the art will recognize that the liquid dispenser 12 is not limited to manual operation as dispensing from liquid dispenser 12 may be accomplished by using a linear actuator (not shown), pneumatic actuation or other types of actuation known in the art. For instance, the stem 34 may be coupled to a linear actuator, which is further coupled to a controller (not shown) for moving the piston 28 relative to the dispensing body 18 by using the linear actuator. Those of ordinary skill in the art will further recognize that embodiments of the invention are not limited to syringe-type dispensers but may be implemented in a wide range of dispensers, including automatic dispensing valves as is also known in the art.

The dispensing body 18 includes a distal end 40 having a luer lock fitting 42 to which dispensing tip 14 is removably coupled. Dispensing tip 14 includes a hub 44 and an elongate tube 46 extending away from hub 44. Hub 44 includes a proximal end 48 adapted to be coupled to the fitting 42 at the distal end 40 of the liquid dispenser 12. For instance, the proximal end 48 may include external threads 50 that cooperate with the luer lock fitting 42 to secure the dispensing tip 14 to the liquid dispenser 12. Those of ordinary skill in the art will recognize other ways to couple dispensing tip 14 to liquid dispenser 12, such as with a retaining collar, as is known in the art. Hub 44 further includes a distal end 52 adapted to be coupled to tube 46. A first passageway 54 extends through hub 44 and fluidly connects the proximal and distal ends 48, 52. When the hub 44 is coupled to the liquid dispenser 12, the first passageway 54 is in fluid communication with the liquid 20 in the reservoir 19 of dispensing body 18 and liquid 20 may flow into and through first passageway 54. Though hub 44 may be formed from any suitable engineering material, preferably, the hub 44 is formed from a suitable engineering plastic, such as carbon powder filled polypropylene.

The elongate tube 46 includes a proximal end 56 that is adapted to be coupled to the distal end 52 of the hub 44 and a distal end 58 having a dispensing orifice 60 out of which the liquid 20 is dispensed onto substrate 16. A second passageway 62 extends through tube 46 and fluidly connects the proximal and distal ends 56, 58. When the tube 46 is coupled to the hub 44, the second passageway 62 in tube 46 is in fluid communication with the first passageway 54 in hub 44 so that liquid 20 may flow from the first passageway 54 to the second passageway 62 and out dispensing orifice 60. Tube 46 may also be formed from any suitable engineering material but preferably is formed from stainless steel, such as 304 stainless steel, through, for example, an extrusion process. The tube 46 may be coupled to hub 44 through a suitable adhesive 63 that can adhesively bond the hub material and tube materials together, as is known in the art. Alternatively, the hub 44 and tube 46 may be formed as an integral unit through, for example, a deep draw process.

In an advantageous aspect, the tube 46 includes a generally cylindrical portion 64 and a tapered or chamfered portion 66 adjacent the distal end 58 of tube 46. The cylindrical portion 64 of tube 46 includes a nominal outer diameter 68, a nominal inner diameter 70 defining second passageway 62 and a nominal wall thickness 72 defined to be one half the difference between the nominal outer diameter 68 and the nominal inner diameter 70. As recognized by those having skill in the art, tubes are commercially available in standard sizes or gauges having fixed and known inner and outer diameters. For instance, a 27 gauge tube has an outer diameter of approximately 0.016 inch and an inner diameter of approximately 0.008 inch. A wide range of gauges, e.g. 14-35 gauge tubing, having known inner and outer diameters are commercially available from a variety of suppliers.

As discussed above, the tube wall thickness at the dispensing orifice 60 is an important factor to providing enhanced control over the dispensing process. Thus, in order to reduce the tube wall thickness at the dispensing orifice 60, a chamfered portion 66 is provided adjacent the distal end 58 of the tube 46. The chamfered portion 66 is of a frusto-conical shape with a reduction in the outer diameter of the tube 46 from the nominal outer diameter 68 to an outer diameter 74 at the dispensing orifice 60 less than the nominal outer diameter 68. Although the inner diameter 76 at the dispensing orifice 60 is generally the same as the nominal inner diameter 70 the reduction in the outer diameter reduces the wall thickness 78 at the dispensing orifice 60. It is the mimization of wall thickness 78 that provides enhanced control of the dispensing process by limiting the capillary forces that cause liquid adjacent the dispensing orifice 60 to flow along the distal face and around the outer edge of the distal end 58.

In addition to the enhanced control of the dispensing process through a reduction in the tube wall thickness 78 at the dispensing orifice 60, forming a chamfer in tube 46 has additional advantages. For instance, such a configuration provides a dispensing tip 10 that has a cylindrical portion 64 that is relatively large and can therefore withstand the structural requirements of the dispensing tip 10, yet also provide a distal end 58 that is relatively smaller with a reduced wall thickness at the dispensing orifice 60 and capable of high-quality, controlled dispensing. The relatively large cylindrical portion 64 also eases assembly during the manufacturing process and handling during use.

While chamfered dispensing tips are generally known and available from various suppliers, the available gauges and wall thicknesses have heretofore been limited. For example, 32 gauge dispensing tips 10 having a chamfered portion 66 are generally not available. Additionally, wall thicknesses at the dispensing orifice 60 are generally not less than approximately 0.0005 inch. A primary reason for the limitation in chamfered dispensing tip sizes is that a grinding process is typically used to form the chamfered portion 66. Of course a grinding process involves physically contacting the tube 46 with a harder, more abrasive material and with a sufficient force or pressure so as to remove material from its outer surface 80. It is known that for larger gauge tubes (smaller diameter tubes) the grinding process mechanically damages the tubes by bending the tube, cracking the tube, collapsing the inner lumen, etc. so as to prevent the tubes from operating in a satisfactory manner. Current grinding processes, for example, are unable to form a chamfered portion 66 in 32 gauge tubes (outer diameter of approximately 0.009 inch) and higher (outer diameter less than approximately 0.009 inch) without damaging the tube.

It is also known that traditional grinding processes also mechanically damage the tubes when the tube wall thickness falls below a critical value. For example, current grinding processes are unable to form a chamfered portion 66 having a wall thickness of less than approximately 0.0005 inch without damaging the tubes. Grinding processes also result in a relatively rough surface finish that may include burrs and other irregularities at the distal end of the tubes that reduce the control and efficiency of the dispensing process.

In an advantageous aspect, the chamfered portion 66 of tube 46 may be formed through a chemical etch process that essentially removes material from the outer surface 80 of tube 46 without mechanical contact between the tube 46 and a harder, more abrasive material, such as a grinding wheel. The chemical etch process uses an etchant, usually an acidic compound or other material known in the art, that dissolves the tube material when in contact with each other. The etchant used in a particular application is primarily determined by the type of material to which it is being applied and the desired rate at which the material will be dissolved to achieve a desired result. In the instant case, those of ordinary skill in the art may select a suitable etchant for dissolving a tube 46 made of 304 stainless steel.

In reference to FIG. 4, to form the chamfered portion 66 in tube 46, a tube 46 may be provided that is generally cylindrical along its entire length. Such un-chamfered tubes are readily commercially available in sizes of 32 gauge and higher. A suitable etchant 82, such as nitric acid, hydrofluoric acid or other suitable etchant known in the art, may be applied to at least a portion of the outer surface 80 of the tube 46 adjacent its distal end 58. To ensure that the etchant 82 is applied only to the desired areas of the tube 46, the remaining portion of tube 46 may be covered with mask 84. Additionally, to prevent etchant 82 from coming into contact with the second passageway 62, the dispensing orifice 60 may be occluded with plug 86. In this way, only the outer surface 80 of the tube 46 along the chamfered portion 66 is contacted by the etchant 82. The etchant 82 then dissolves the tube material along its outer surface 80. Those of ordinary skill in the art will recognize that because the dissolving rate of the etchant/tube material combination is generally known, the tube 46 and etchant 82 may remain in contact with each other in a manner that forms the chamfered portion 66 in the tube 46. By way of example, the tube 46 may be inserted or withdrawn from a bath 88 of the etchant 82 in a manner that forms the chamfered portion 66. When a tube 46 is inserted into bath 88, for example, the portion of tube 46 adjacent distal end 58 will be in contact with etchant 82 for a longer period of time relative to a more proximal portion of the tube 46 as the tube is inserted into bath 88. This allows more material to be removed as one moves distally along tube 46. A similar contact time process is at work when removing a tube from an etchant bath. Embodiments of the invention are not so limited as other techniques known in the art, such as various spraying techniques, may be used to form the chamfered portion 66. The rate at which the tube 46 is inserted or withdrawn from bath 88 depends on the specific application including the etchant/tube material combination, type of chamfer desired (e.g., short or long chamfer; shallow or steep chamfer), etc. In any event, one of ordinary skill in the art may determine an insertion/withdrawal rate to achieve a desired chamfered portion configuration.

Forming the chamfered portion 66 in tube 46 using a chemical etch process has a number of advantages. Because the chemical etch process removes material by dissolving instead of through physical contact, the limitations associated with the traditional grinding processes of dispensing tips can be overcome. In particular, through the chemical etch process, it is now possible to form chamfers in tubes with sizes of 32 gauge and higher. Thus, 32 gauge and higher dispensing tips having chamfered ends may now be offered. This is particularly advantageous in those dispensing applications where a cylindrical portion 64 of 32 gauge (or higher) is necessary to withstand the structural requirements of the dispensing tip while a reduced diameter and reduced wall thickness distal end is desired to control the amount of liquid dispensed or the location of the dispensed liquid. Moreover, a dispensing tip having the tube wall thickness at the dispensing orifice less than approximately 0.0005 inch may also be offered. Thus, good control of the dispensing process may be achieved. Additionally, the chemical etch process produces a smooth, burr-free surface adjacent the distal end.

While the embodiments shown and described above have tubes that are substantially circular in cross section, the invention is not so limited as those of ordinary skill in the art will recognize that tubes with non-circular cross sections may be used. In another embodiment of the invention, as shown in FIGS. 5A and 5B, the dispensing tip 14 may include an elongate tube 46 having a substantially triangular, rectangular, or other polygonal cross-sectional shape. The chamfered portion of the dispensing tip may be formed using a chemical etch process in essentially the same manner as that described above for the circular cross-sectional tube. For tubes having a polygonal cross-sectional shape, the chemical etch process may slightly round the corners between adjacent sides of the polygon.

In yet another embodiment of the invention, instead of substantially the entire length of the tube having the non-circular cross section, just a portion of the tube may have a non-circular cross section. By way of example, either before or after forming the chamfered portion 66 in the tube 46 having a substantially circular cross section, the distal end 58 of the tube 46 may be deformed so as to have a non-circular cross section. Thus, an additional processing step may reshape to distal end 58 of the tube 46 to have a triangular, rectangular or other polygonal shape.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user.

What is claimed is:

1. A dispensing tip for a liquid dispenser, comprising:
a hub having a proximal end, a distal end and a first passageway fluidly coupling said proximal and distal ends of said hub, wherein said proximal end of said hub is adapted to couple to the liquid dispenser;
a tube having a proximal end, a distal end defining a dispensing orifice and a second passageway fluidly coupling said proximal and distal ends of said tube, wherein said proximal end of said tube is coupled to said distal end of said hub such that said first and second passageways are in fluid communication, said tube having a maximum outer diameter of approximately 0.009 inch or less; and
a chamfered portion formed adjacent said distal end of said tube such that a tube wall thickness at said dispensing orifice is less than a tube wall thickness upstream of said dispensing orifice.

2. A dispensing tip for a liquid dispenser, comprising:
a hub having a proximal end, a distal end and a first passageway fluidly coupling said proximal and distal ends of said hub, wherein said proximal end of said hub is adapted to couple to the liquid dispenser;
a tube having a proximal end, a distal end defining a dispensing orifice and a second passageway fluidly coupling said proximal and distal ends of said tube, wherein said proximal end of said tube is coupled to said distal end of said hub such that said first and second passageways are in fluid communication; and
a chamfered portion formed adjacent said distal end of said tube such that a tube wall thickness at said dispensing orifice is less than a tube wall thickness upstream of said dispensing orifice, wherein said tube wall thickness at the dispensing orifice is less than approximately 0.0005 inch.

3. The dispensing tip of claim 2, wherein said tube has a cross section selected from the group consisting of a substantially circular cross section, a substantially triangular cross section, a substantially rectangular cross section and combinations thereof.

4. A method of making a dispensing tip for a liquid dispenser, comprising:
providing a tube having an outer surface and an inner surface defining a passageway through the tube;
applying a chemical etchant to at least a portion of the outer surface of the tube; and
forming a chamfered portion in the tube through application of the chemical etchant.

5. The method of claim 4, wherein the tube has a substantially circular cross section having an outer diameter of approximately 0.009 inch or less.

6. The method of claim 4, wherein applying the etchant to the tube further comprises:
immersing at least a portion of the tube in a bath of the etchant.

7. The method of claim 6, wherein forming the chamfered portion further comprises:
immersing an end portion of the tube in the bath of the etchant to a first depth; and
immersing the end portion of the tube in the bath of the etchant to a second depth different than the first depth.

8. The method of claim 4, wherein the chamfered portion defines a minimum tube wall thickness less than approximately 0.0005 inch.

9. The method of claim 4, further comprising:
coupling an end of the tube opposite the chamfered portion to a hub.

10. The method of claim 4, further comprising:
maintaining the inner surface of the tube when applying the chemical etchant to the tube.

11. The method of claim 4, further comprising:
preventing the chemical etchant from entering the passageway when applying the chemical etchant to the tube.

12. The method of claim 4, further comprising:
sealing an outlet of the passageway prior to applying chemical etchant to the tube; and
removing the seal after forming the chamfered portion in the tube.

13. The method of claim 4, further comprising:
reshaping at least a portion of the tube from a first cross-sectional shape to a second cross-sectional shape different from the first cross-sectional shape.
